(19) United States
(12) Patent Application Publication
(10) Pub. No.: US 2016/0063534 A1
(43) Pub. Date: Mar. 3, 2016

(54) Customer Exercise Reward Method And Shopping Cart For Same

(71) Applicant: M. Fazni Aziz, Bloomington, IN (US)

(72) Inventor: M. Fazni Aziz, Bloomington, IN (US)

(21) Appl. No.: 14/469,078

(22) Filed: Aug. 26, 2014

(51) Int. Cl. G06Q 30/02; B62B 3/14

(52) U.S. Cl. CPC G06Q 30/0238; B62B 3/14; B62B 3/1416; B62B 3/1424

(57) ABSTRACT

A customer exercise reward method includes measuring work done by a customer and pushing a shopping cart through a store. At a check out location in the store, a customer reward is determined proportional to the work done. An amount due by the customer to the store for items brought by the customer from item locations in the store to the check out location is determined. At least a portion of the customer reward is redeemed by reducing the amount due.

### TECHNICAL FIELD

The present disclosure relates generally to a customer exercise reward method that utilizes a shopping cart, and more particularly to a customer reward based upon work done by a customer in pushing the shopping cart through a store.

### BACKGROUND

On average, it is believed that store customers that choose to utilize a shopping cart tend to purchase more items from a store relative to other customers who choose a hand held basket or choose no carrying device at all. Rewarding customers is also believed to improve good will in relations between a customer and a store, and improved good will generally translates into higher sales. As an example, U.S. Patent Application Publication to 2002/0121547 teaches a method and system for detecting and rewarding customers for the use of a shopping cart in a hyper market. Although the strategy taught in the reference may promote the use of shopping carts, it does nothing to promote shopping activity, which includes moving through a store and examining a variety of items displayed and offered for sale throughout the store.

The present disclosure is directed toward an improved strategy for promoting sales by rewarding customers for shopping behavior.

### SUMMARY

In one aspect, a customer reward method includes measuring work done by a customer in pushing a shopping cart through a store. The shopping cart includes a framework supported by a first front swivel wheel, a second front swivel wheel, a first back wheel and a second back wheel. The framework is movable between a shopping configuration and a nested storage configuration. The framework defines a basket in the shopping configuration, and the basket is partially defined by a back wall and a pair of side walls that are separated by a width that narrows from the back wall toward a front wall of the basket. The back wall pivots from a vertical orientation to a horizontal orientation when the framework is changed from the shopping configuration to the nested storage configuration. The framework also includes a push handle. A customer reward is determined at a check out location that is proportional to the work done measurement. An amount due is determined from the customer to the store for items bought by the customer from item locations in the store to the check out location. At least a portion of the customer reward is redeemed by reducing the amount due.

In another aspect, a shopping cart includes a framework supported by a first front swivel wheel, a second front swivel wheel, a first back wheel and a second back wheel. The framework is movable between a shopping configuration and a nested storage configuration. The framework defines a basket in the shopping configuration, and the basket is partially defined by a back wall and a pair of side walls that are separated by a width that narrows from the back toward a front wall of the basket. The back wall pivots from a vertical orientation to a horizontal orientation when the framework is changed from the shopping configuration to the nested storage configuration. The framework includes a push handle. A measuring device is attached to the framework and coupled to at least one of the first back wheel and a second back wheel. The measuring device stores a work done measurement that increases responsive to movement of the shopping cart, and the measuring device includes a reset configured to initialize the work done measurement.

### BRIEF DESCRIPTION OF THE DRAWINGS

FIG. 1 is a perspective view of a shopping cart according to one aspect of the present disclosure;

FIG. 2 is a schematic view of a work done measuring device according to another aspect of the present disclosure;

FIG. 3 is a schematic view of a control and display panel for the shopping cart of FIG. 1;

FIG. 4 is a top view of a store with shoppers pushing shopping carts according to the present disclosure; and

FIG. 5 is a logic scenario for carrying out the method of the present disclosure.

### DETAILED DESCRIPTION

The present disclosure teaches a customer reward method and an example shopping cart that is equipped with features for carrying out the method. Broadly speaking, the method of customer reward includes measuring work done by a customer in pushing a shopping cart through a store, and then determining at a check out location in the store a customer reward that is proportional to the work done. At least a portion of the customer reward is redeemed by reducing an amount due for items brought by the customer from item locations in the store to the check out location. A variety of levels of sophistication can be brought to bear in order to practice the customer reward method of the present disclosure. For instance, the method could be accomplished with a shopping cart that included a simple electronic or mechanical device that counted the number of wheel rotations during the customer's shopping experience. In a more sophisticated version, which is described infra, the shopping cart is equipped with a measuring device that includes an electrical generator that generates electricity responsive to the customer pushing the shopping cart through the store.

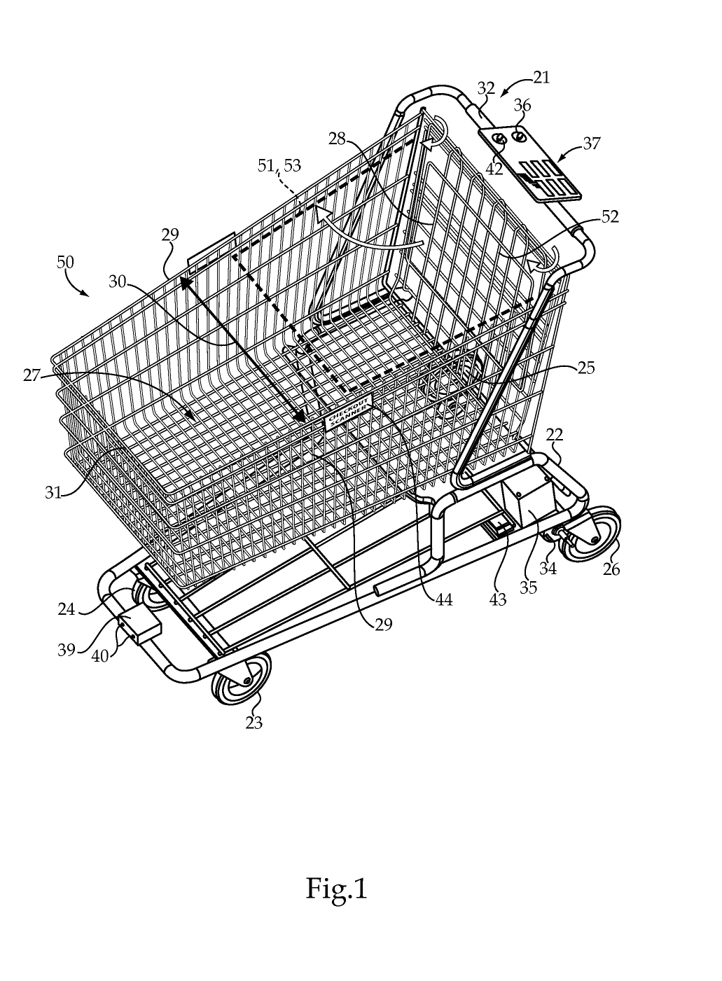

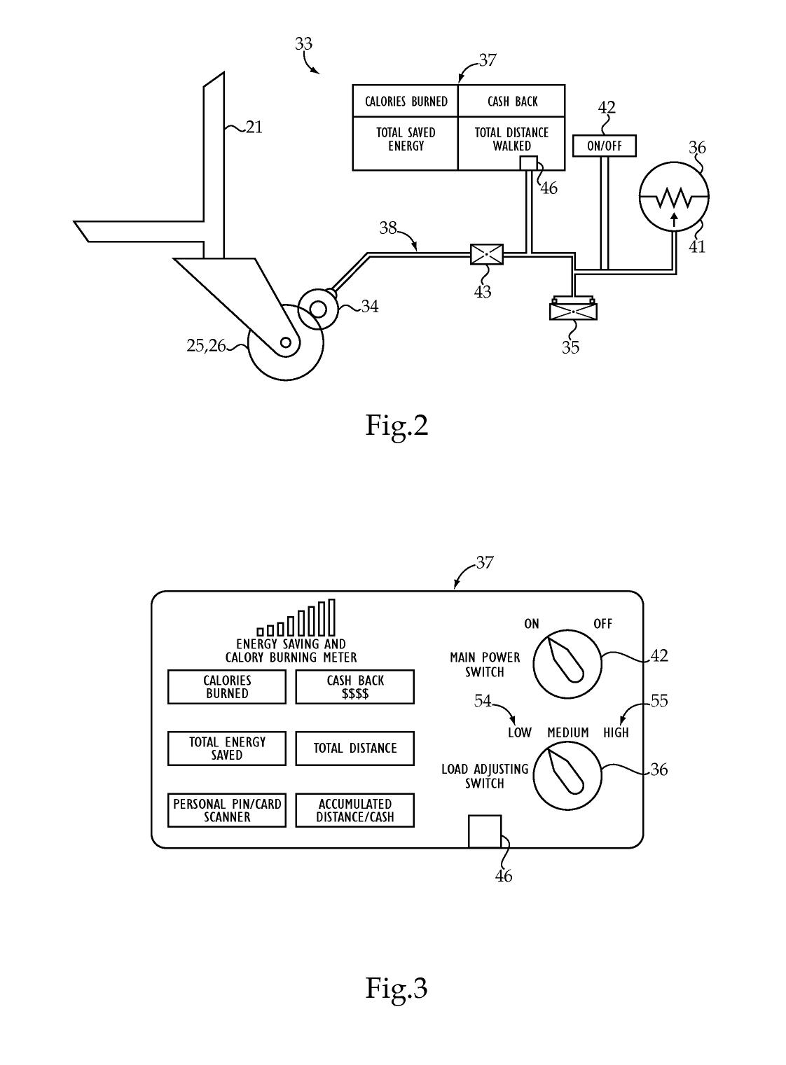

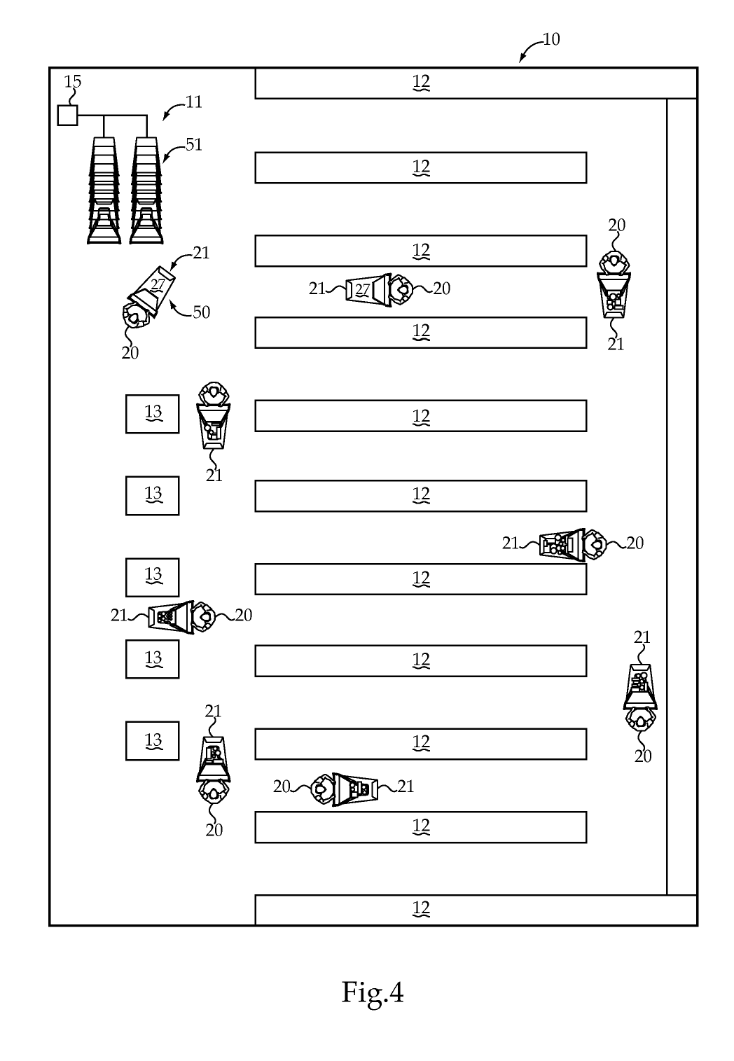

Referring now to FIGS. 1-3, a shopping cart 21 according to the present disclosure includes a framework 22 supported by a first front swivel wheel 23, a second front swivel wheel 24, a first back wheel 25 and a second back wheel 26. The framework is movable between a shopping configuration 50 as shown, and a nested storage configuration 51 (see also FIG. 4). The framework 22 defines a basket 27 in the shopping configuration 50 for temporarily storing the items to be purchased by the customer as they maneuver through the store. The basket 27 is partially defined by a back wall 28 and a pair of sidewalls 29 that are separated by a width 30 that narrows from the back wall 28 toward a front wall 31 of the basket 27. The back wall 28 pivots from a vertical orientation 52, as shown, to a horizontal orientation 53 (shown with dotted lines) when the framework 22 is changed from the shopping configuration 50 to the nested storage configuration 51. The framework 22 also includes a push handle 32.

Apart from the typical features of a shopping cart, shopping cart 21 includes a measuring device 33, which is attached thereto, and includes a watt meter 46 and an electrical generator 34 operably coupled to one or more of the wheels 23-26 of shopping cart 21. In the illustrated example, shopping cart 21 includes electrical generator 34 operably coupled to one of the back wheels 25, 26 and electrically connected to a circuit 38. Electrical energy generated by generator 34 in response to rotation of back wheel 25, 26 may pass through a voltage regulator 43, be measured by watt meter 46 and be supplied to power a display 37, which may be mounted on or adjacent push handle 32, and a storage battery 35. In order to balance the torque placed upon back wheel 25, 26 by generator 34, shopping cart 21 may include two generators with one each operably coupled to each of the respective back wheel 25, 26. An on/off switch 42 may be included, and possibly incorporated as part of display 37 so that measuring device 33 can be enabled or disabled. Measuring device 33 may also include an adjustment device 36 that is capable of changing an inertia of shopping cart 21. In this example, adjustment device 36 takes the form of a variable resistor 41 that is electrically connected to circuit 38. The adjustment device 36 can be moved between a low inertia configuration 54 and a high inertia configuration 55. Those skilled in the art will appreciate that the work done measurement is produced by pushing the shopping cart 21 through the store. For practical purposes, the generator 34 becomes more difficult to rotate at the high inertia configuration than at the low inertia configuration 54. Thus, the inertia of shopping cart 21 increases responsive to the adjustment device 36 being moved from the low inertia configuration to the high inertia configuration. A customer who chooses a high the high inertia configuration 55 could expect to perform more work in pushing shopping cart 21 through the store, and thus accumulate a larger customer reward than an identical shopping experience with a shopping cart 21 set at the low inertia configuration 54. In the illustrated embodiment, output from generator 34 may be monitored by a watt meter 46 that is configured to determine an amount of work done by integrating the output of the generator 34 over time. This information can be then communicated to display 37 after application of appropriate conversion factors to provide the customer with up-to-date information with regard to their accumulated customer reward and associated data regarding such things as calories burned, and distance walked, among other things. Watt meter 46 is electrically connected to circuit 38. Readers will appreciate that programming necessary to carry out these functions is well within the realm of routine skill in the art, and need not be taught here. Those skilled in the art will appreciate that measuring device 33 may include watt meter in a more sophisticated version of the disclosure. However, a simple mechanical counting device that simply counted the number of rotations of a wheel 23-26 of shopping cart 21 and provided a visual indication of the number of rotations would also fall within the intended scope of the present disclosure, representing a less sophisticated measuring device 33 according to the present disclosure. In any event, measuring the work done by the customer may be performed responsive to rotation of at least one support wheel 23-26 of shopping cart 21. Depending upon the desired level of sophistication, display 37 can provide real time information regarding the amount of work done thus far in the customer shopping experience might also display exercise related information such as a power level or rate at which work is being measured by measuring device 33. Also, the display 37 may include customer reward information and any suitable information related to the task of measuring the amount of work done and providing information useful to the customer regarding the customer reward. In addition, the display 37 may be equipped with other features such as a port for charging mobile phones and other devices during shopping, a pedometer to show the number of steps a customer took during shopping, an odometer that might show speed and total distance traveled by the customer while shopping. In addition and although not necessary, display 37 might also power an entertainment screen for children while shopping or a screen to show product commercials and items to the customer during the shopping experience.

Shopping cart 21 may also be equipped with an energy discharger 39 that is attached to framework 22 and electrically coupled to battery 35. The energy discharger 39 may include a pair of electrical terminals 40 that allow extraction of accumulated electrical energy stored in battery 35 to be offloaded by the store to perform some purpose, such as power some part of the store or another device. Although not necessary, shopping cart 21 may also be equipped with a checkout scanner 44 that provides a means of wirelessly communicating the work done measurement information from shopping cart 21 to a checkout computer when shopping cart 21 passes through a checkout location 13 in the store. For instance, watt meter 46 may be equipped with a short range radio frequency transmitter that broadcasts work done information to a receiver at the checkout location 13 so that the store may then determine the customer reward proportional to the work done. As used in this disclosure, the word “proportional” need not necessarily mean a linear relationship. Instead, proportional merely means that more work done corresponds to a larger customer reward. In less sophisticated versions of the invention, the checkout operator may utilize some other means, including simple visual observation, in order to obtain the work done measurement for that shopping experience and enter that information manually into the store computer and checkout system.

The features relating to measuring device 33 may be added to an existing shopping cart by installing one or more voltage generators 34 to the shopping cart 21, and coupling the generator(s) 34 with one or more of the wheels 23-26 of shopping cart 21. The drive ratio of the generator 34 to wheel 23-26 might be arranged such that an average walking speed will produce a nominal battery voltage. The generator(s) 34 is preferably mounted in a way to equally spread the load on the wheels 25, 26, so that the shopping cart 21 could be pushed straight without any side loads caused by measuring device 33. Apart from the embodiment illustrated, this could be achieved by installing a separate generator on every wheel, or only to the front wheels 23, 24, or only to the rear wheels 25, 26, as shown. Also, it is possible that a differential mechanism could be used if generators are not attached to every wheel.

Although not necessary, one or more batteries 35 may be attached to shopping cart 21 for storing electrical energy. The voltage regulator 43 may be utilized between generator 34 and battery 35 in order to prevent battery 35 from being overcharged. The on/off switch 42 and adjustment device 36 may be electrically connected to circuit 38 so that the customer can easily activate measuring device 33 and/or to change resistance of the charging and work done measuring feature.

### INDUSTRIAL APPLICABILITY

The present disclosure finds potential applicability to any store where customers have a choice of using a shopping cart to collect their items for purchase during a shopping experience through the store. The present disclosure finds specific application to stores that could benefit by incentivizing customers to use a shopping cart during the customer's visit to the store. The present disclosure finds additional applicability in improving customer goodwill to a store, and hence business with the store, by rewarding customers for exercising through pushing a shopping cart through the store during their shopping experience.

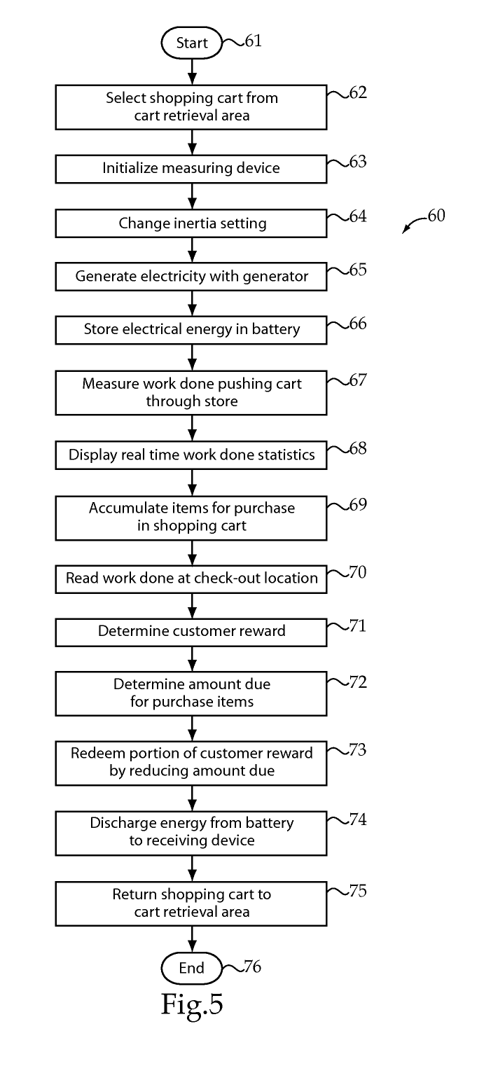

Referring now in addition to FIGS. 4 and 5, an example shopping experience according to the present disclosure is illustrated by an aerial view of a store 10 along with a logic scenario for performing the customer reward method of the present disclosure. The logic starts at oval 61 with a customer 20 entering store 10 and retrieving a shopping cart 21 from a cart retrieval area 11. As is typical in a store 10, the shopping carts 21 in cart retrieval area 11 are in a nested storage configuration 51. When the outermost shopping cart 21 is retrieved from the cart retrieval area, the back wall 28 will move from its horizontal configuration to its vertical configuration associated with the shopping cart 21 now being in a shopping configuration 50. This aspect of the logic is illustrated in block 62. At block 63, the measuring device 33 is maybe initialized. For instance, the measuring device 33 may be initialized by the action of the back wall 28 moving from its horizontal orientation 53 to its vertical orientation 52. Nevertheless, those skilled in the art will appreciate that the measuring device 33 may be initialized by placement of the shopping cart 26 into the nested storage configuration 51 such as after the shopping cart has been used and is returned to the cart retrieval area 11 for a subsequent shopper. Measuring device 33 may be initialized in any suitable manner without departing from the intended scope of the present disclosure. Initialization may also include noting accumulated energy measured by watt meter 46 when the shopping cart 21 is taken from cart retrieval area 11. The shopper 20 can then decide whether or not to participate in the customer reward program by moving on/off switch 42 to the appropriate position. Assuming that the customer chooses the on position, the customer can then at box 64 move adjustment device 36 to a chosen inertia setting for shopping cart 21, as shown at the display 37 of FIG. 3. The customer then departs from the cart retrieval area 11 and begins moving through store 10 by pushing shopping cart 21 along aisles between item locations 12 throughout store 10. At box 65, the generator 34 will respond to movement of shopping cart 21 by generating electricity responsive to rotation of wheels 25, 26. Some or all of this electricity may be stored at box 66 in battery 35. Or some of the electrical energy may be used to power some aspect of display 37. In any event, the amount of work done in pushing shopping cart 21 will be measured by sensing the output from generator 34, such as by watt meter 46. This aspect is illustrated by box 67. At box 68, the display 37 may indicate real time work done statistics and an accumulated customer reward, and maybe other exercise related data of interest, such as calories burned, the total dollar value of the customer reward thus far, a total distance traveled, total energy saved, and may even include work rate or power information in a suitable manner. At box 69, the customer will accumulate items for purchase in the basket 27 of their shopping cart 21. Eventually, the customer will finish shopping and maneuver shopping cart 21 to a checkout location 13 in store 10. Depending upon the features chosen, the work done measurement may be automatically read at the checkout location 13 by scanning checkout scanner 44 as the shopping cart enters checkout location 13 as per box 70. At box 71, the store computer may independently determine the customer reward that is proportional to the work done measurement. At the same time, the checkout location operator will determine an amount due by customer 20 to the store for items brought by the customer 20 from item locations 12 in the store to the checkout location 13. This is indicated at box 72. At box 73, the customer 20 may redeem a portion or all of the customer reward by reducing the amount due by an amount that corresponds to the customer reward. Those skilled in the art will appreciate that customer rewards may be tracked by store 10 as points until such time as they are redeemed and converted to a dollar amount at time of redemption. At box 74, stored energy from battery 35 may be discharged to a receiving device 15, which may be at the checkout location 13. Otherwise, at box 75, a store employee or the customer 20 may return shopping cart 21 to the cart retrieval area 11. If so desired, the store may locate a receiving device 15 at the cart retrieval area 11 and provide means by which the energy discharger 39 attached to each shopping cart 21 and the associated pair of terminals 40 can be electrically connected to the receiving device 15 to discharge the stored energy from the battery 35. Alternatively, the discharge may be performed at the end of the day when all the shopping carts 21 are joined and all the stored energy from the batteries is transferred to a separate storage receiving device 15 where the power could be used to power up some other part of the store or another device of choice.

Those skilled in the art will appreciate that when the customer 20 walks into store 10 and takes one of the shopping carts 21 to shop, the first thing he or she will do will decide if they desire to be rewarded for their exercise in pushing the shopping cart through the store. If not, they have the option of turning the main on/off switch 42 to off and use shopping cart 21 as a regular cart. On the other hand, if they turn on/off switch 41 to on, they may then set the inertia to appropriate level with adjustment device 36. Of course, the lower the setting the easier it will be to push shopping cart 21, and also the shopping cart 21 will save less energy which will mean a smaller customer reward at the end of the shopping experience. While pushing shopping cart 21, display 37 may show information about calories burned, the rate at which the battery 35 is charging, the rate and total reward in dollars/points, the total distance traveled, etc. At the end of the shopping experience, the customer 20 will come to the checkout location 13 and pay for their items. Although not necessary, shopping cart 21 may be equipped with some suitable device, such as a weighing machine, to adjust the work done measurement by the mass of the items carried in the basket 27 of shopping cart 21. In any event, the customer may either redeem the saved customer reward or have the customer reward credited toward the current purchases or saved for future use in dollars or points.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A customer reward method, comprising the steps of:
measuring work done by a customer in pushing a shopping cart through a store, and the shopping cart includes a framework supported by a first front swivel wheel, a second front swivel wheel, a first back wheel and a second back wheel; the framework being movable between a shopping configuration and a nested storage configuration; the framework defining a basket in the shopping configuration, and the basket is partially defined by a back wall and a pair of side walls that are separated by a width that narrows from the back wall toward a front wall of the basket; the back wall pivoting from a vertical orientation to a horizontal orientation when the framework is changed from the shopping configuration to the nested storage configuration; and, the framework including a push handle;
determining, at a check out location in the store, a customer reward that is proportional to the work done;
determining an amount due from the customer to the store for items brought by the customer from item locations in the store to the check out location; and
redeeming at least a portion of the customer reward by reducing the amount due.

2. The method of claim 1 wherein the measuring step is performed by a measuring device attached to the shopping cart.

3. The method of claim 2 wherein the measuring step is performed responsive to rotation of at least one support wheel of the shopping cart.

4. The method of claim 3 including a step of generating electricity responsive to the rotation of the at least one support wheel of the shopping cart with a generator attached to the shopping cart.

5. The method of claim 4 including a step of storing energy of the electricity in a battery attached to the shopping cart.

6. The method of claim 5 including a step of changing an inertia of the shopping cart with an adjustment device attached to the shopping cart.

7. The method of claim 6 including a step of displaying, on a display attached to the shopping cart, data generated by the measuring device.

8. The method of claim 7 including a step of discharging energy from the battery to a receiving device of the store.

9. The method of claim 8 including the steps of:
moving the shopping cart from the checkout location to a cart retrieval area of the store; and
initializing the measuring device.

10. The method of claim 9 wherein the step of changing the inertia includes changing an electrical resistance in a circuit electrically connected to the generator.

11. A shopping cart comprising:
a framework supported by a first front swivel wheel, a second front swivel wheel, a first back wheel and a second back wheel;
the framework being movable between a shopping configuration and a nested storage configuration;
the framework defining a basket in the shopping configuration, and the basket is partially defined by a back wall and a pair of side walls that a separated by a width that narrows from the back wall toward a front wall of the basket;
the back wall pivoting from a vertical orientation to a horizontal orientation when the framework is changed from the shopping configuration to the nested storage configuration;
the framework including a push handle; and
a measuring device attached to the framework and coupled to at least one of the first back wheel and the second back wheel, and the measuring device storing a work done measurement that increases responsive to movement of the shopping cart, and the measuring device including a reset configured to initialize the work done measurement.

12. The shopping cart of claim 11 wherein the measuring device includes a generator that rotates responsive to rotation of at least one of the first back wheel and the second back wheel.

13. The shopping cart of claim 12 including an adjustment device attached to the framework and being movable between a low inertia configuration and a high inertia configuration;
wherein the work done measurement increases at a greater rate in the high inertia configuration than the low inertia configuration responsive to equal movements of the shopping cart;
an inertia of the shopping cart increases responsive to the adjustment device being moved from the low inertia configuration to the high inertia configuration.

14. The shopping cart of claim 13 including a battery attached to the framework and electrically coupled to the generator; and
an energy discharger attached to the framework and electrically coupled to the battery and including a pair of electrical terminals.

15. The shopping cart of claim 14 including a display attached to the framework and configured to display the work done measurement.

16. The shopping cart of claim 15 wherein the adjustment device includes a resistor in an electrical circuit electrically connected to the generator.
